(19) United States
(12) Patent Application Publication
(10) Pub. No.: US 2007/0204153 A1
(43) Pub. Date: Aug. 30, 2007

(54) TRUSTED HOST PLATFORM

(76) Inventors: Agustin J. Tome, Leesburg, VA (US); Cary Riddock, Ashburn, VA (US); Paul J. Smalser JR., Ashburn, VA (US); Kenneth Robert Ruof, Centreville, VA (US); Karl Ginter, Beltsville, MD (US)

Correspondence Address: PILLSBURY WINTHROP SHAW PITTMAN, LLP, P.O. BOX 10500, MCLEAN, VA, 22102, US

(21) Appl. No.: 11/620,008

(22) Filed: Jan. 4, 2007

Related U.S. Application Data
(60) Provisional application No. 60/755,849, filed on Jan. 4, 2006.

(51) Int. Cl. H04L 9/00

(52) U.S. Cl. 713/164

(57) ABSTRACT

The invention provides methods and apparatus, including computer program products, implementing and using techniques for providing access from a trusted host platform to a first secured network operating on a first security domain and a second secured network operating on a second security domain. In some embodiments, a first virtual machine associated with the first secured network is instantiated on the trusted host platform. A second virtual machine associated with the second secured network is also instantiated on the trusted host platform. A first connection is established between the first virtual machine on the trusted host platform and the first secured network using at least a first virtual secure storage device. A second connection also established between the second virtual machine on the trusted host platform and the second secured network using at least a second virtual secure storage device. Furthermore, movement of information from within the first security domain to the second security domain is controlled.

### CROSS-REFERENCE TO RELATED APPLICATIONS

This application claims priority to U.S. Provisional Application No. 60/755,849 entitled “Trusted Host Platform” which was filed on Jan. 4, 2006, the entirety of which is incorporated herein by reference. This application is related to U.S. patent application Ser. No. ______ (to be determined) entitled “Trusted Host Platform” filed on Jan. 4, 2007, the entirety of which is also incorporated herein by reference.

### BACKGROUND

This invention relates to a trusted host platform that permits a single trusted host platform to simultaneously interface with several disparate security domains, each of which is managed disparately, and which do not share a common or federated trust model.

Conventional “trusted networks” include various networks of differing security classifications that meet at a desktop using a single multi-homed compartmented workstation, several workstations, or a thin client computer. The virtualized platform is trusted by virtue of its location, deployment, and certifications and accreditations. Functionality is limited between virtualized machines: for example, cut-and-paste between windows is not permitted. Similarly, functionality is limited in that a single certificate is provided on a single smart card, requiring the simultaneous use of several smart cards and several smart card readers. There is also a forced association of a smart card reader with a specific virtual machine, which raises manufacturing costs and system complexity. What is needed is an improved a trusted host platform.

### SUMMARY

According to various embodiments of the invention, a trusted host platform operates in an independent network to simultaneously securely connect to and operate on multiple other independent networks (security domains) without exposing the various security domains to each other, while protecting and maintaining separation of data within each security domain. The trusted host platform includes numerous improvements and refinements over extant systems that permit this functionality to be provided less expensively and with higher reliability and levels of assurance.

In some embodiments of the invention, a security domain may include a “provisioning” domain. This security domain supports provisioning of smart cards independently of other, application or usage specific, security domains. A provisioning security domain is advantageous when using a multiple certificate smart card.

Each security domain may include at least one certificate authority (CA), which is functionally used to create several types of certificates used by the trusted host platform. These certificates include VPN user/IPSec certificates (e.g., permits use of IPSec connectivity to security domain), machine certificate (e.g., identifies authorized machines within the security domain), user certificate (e.g., identifies a user as a member of the security domain), domain administrator certificate (e.g., identifies a user as a security domain administrator), and/or enrollment agent certificate (e.g., identifies a user as an enrollment agent). Other certificates may also be created and used by the security domain. These certificates may be created by the security domain CA, or may be delegated to another CA within the security domain

The security domain may include at least one desktop representation server, such as a Citrix server or a Microsoft operating system that supports Microsoft Terminal Services, both of which are commercially available. The trusted host platform functions to operably form a secure connection between a virtual machine instance operating on the trusted host platform and a desktop representation server in order to use desktop services (e.g., applications software such as database and word processing software, data sources) provided by the security domain.

The security domain may include at least one Virtual Private Network (VPN) concentrator or VPN endpoint device, which provides a VPN termination and authorization function for the security domain. The VPN concentrator authenticates a requested VPN session, and manages and implements the security domain side of a VPN connection. Preferably, the VPN concentrator provides authentication at least in part using a VPN certificate, described above.

To connect securely, the trusted host platform opens a virtual machine instance, which in turn opens a VPN connection to the VPN concentrator of the security domain. The VPN connection between a specific hosted virtual machine in the trusted host platform and the VPN concentrator protects the data (e.g., using encryption) moving through the VPN connection over the insecure (e.g., “untrusted”) portion of the network. Thus, the data is not exposed to unauthorized capture or review.

A trusted host platform may include various elements, such as a virtual machine, a smart card reader, applications, and/or network interface peripherals. The trusted host platform may be used to access one or more disparate security domains independently.

The virtual machine may include information for virtual machine configuration/images, virtual machine provisioning, and/or network interface to virtual interface mapping. Virtual machine provisioning may include domain specific certificates stored within virtual machine images, or a master virtual image that is not security domain specific may be stored and different virtual machine instances may be configured using that master virtual image using security domain specific certificates. In some embodiments, a smart card may be used to externally store master and virtual machine certificates for configuration at boot time; therefore, no certificates are stored in the virtual image storage memory.

A smart card reader may be used to read the smart card with stored virtual machine certificates, security domain certificates, and security domain specific VPN connection information. Smart card reader(s) may include biometric devices for added security. Smart card readers may be virtualized to allow access to multiple security domains independently using a single smart card.

The various applications implemented by the trusted host platform may include, but are not limited to, tamper detection/watchdog, write guard, guard, clipboard, and card removal.

In some embodiments, the virtual machine may be security domain specific and may be pre-configured with at least one of a machine domain membership certificate, a security domain VPN use certificate, and VPN connection information. The virtual machine, upon startup, may use these certificates and configuration information along with a user's certificate, which in some embodiments may be stored in a smart card, in conjunction with the VPN materials, to create a VPN connection between the virtual machine and the security domain's VPN concentrator. If connections to multiple security domains are desired, one virtual machine may be configured for each security domain. These operations may be performed using various conventional techniques.

In some embodiments, the virtual machine may not be security domain specific. In these embodiments, the machine domain membership certificate, the security domain VPN certificate, and the VPN connection information may be stored externally to the virtual machine, for example, in a smart card along with the user's certificate. At boot, the virtual machine maps the smart card, and uses at least one of the certificates and configuration materials in the smart card in conjunction with the VPN software to establish a VPN connection between the virtual machine and the security domain's VPN concentrator. An advantage of these embodiments is that a single virtual machine image may be used and all virtual machine personalization may be provided by the certificates and materials stored within a smart card, and no certificates are stored in virtual machine images.

In some embodiments, the VPN connection materials may be encoded within a X.509 VPN use certificate. Thus, the X.509 certificate may encode a DNS name for the security domain's VPN concentrator, along with other connection-required materials.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is an illustration of a conventional computer network.

FIG. 2 is a diagram of computer network, in accordance with various embodiments of the invention.

FIG. 3 is a block diagram of a host platform, in accordance with various embodiments of the invention.

FIG. 4 is an illustration of prior art multi-certificate smart card.

FIG. 5 is a diagram of virtual smart cards, in accordance with various embodiments of the invention.

FIG. 6 is a flow chart for smart card provisioning, in accordance with various embodiments of the invention.

FIG. 7 is a flow chart for self-provisioning of smart card, in accordance with various embodiments of the invention.

FIG. 8 illustrates the functional information flow between and within a trusted host platform and one or more secured networks in accordance with various embodiments of the invention.

Like reference symbols in the various drawings indicate like elements.

### DETAILED DESCRIPTION

Conventional Trusted Networks

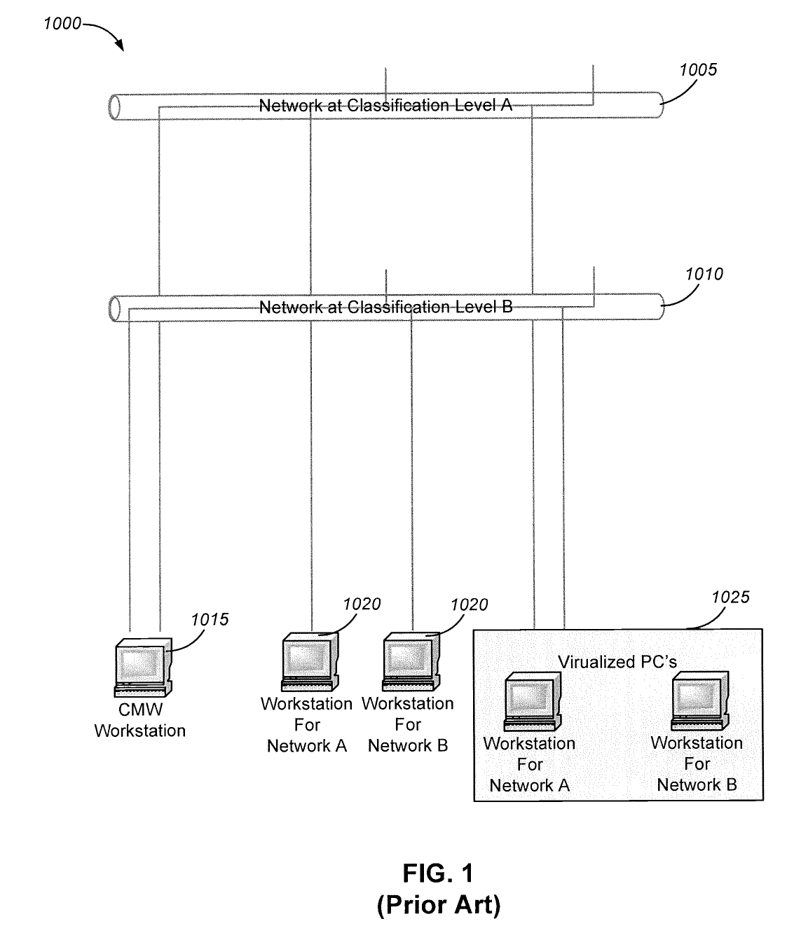

FIG. 1 shows a conventional trusted network architecture (1000. Network architecture (1000) includes multiple networks (1005; 1010) of differing security classifications that meet at the desktop using a single multi-homed compartmented workstation, several workstations, or a thin client computer. The workstations shown in FIG. 1 may include a compartmented workstation (1015), several individual workstations (1020), a virtualized host platform (1025), or other workstations. The virtualized platform (1025) is trusted by virtue of its location, deployment, and certifications and accreditations. Functionality is limited between virtualized machines: for example, cut-and-paste between windows is not permitted. Similarly, functionality is limited in that a single certificate is provided on a single smart card, requiring the simultaneous use of several smart cards and several smart card readers. There is also a forced association of a smart card reader with a specific virtual machine, which raises manufacturing costs and system complexity.

Numerous improvements to conventional trusted host platforms are described herein. These improvements include increasing the native trust level of the device, supporting multi-certificate smart cards, making the trusted host platform device tamper resistant, adding cross session information movement, and migrating the trusted host platform from a secured desktop environment to a variety of platforms.

Trusted Host Platform

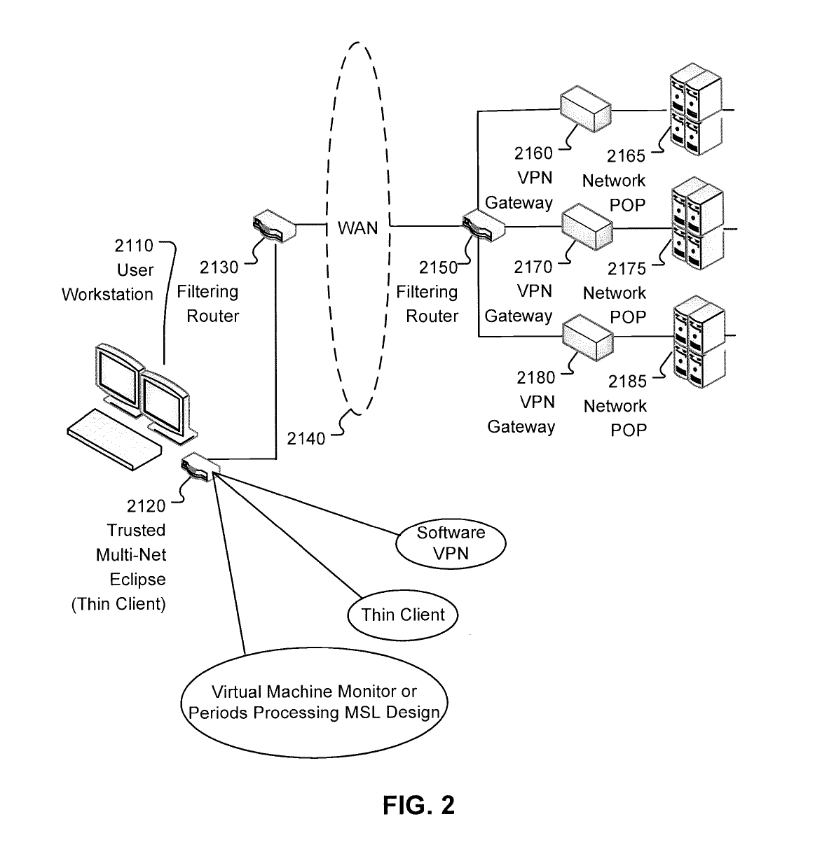

FIG. 2 illustrates an example of a trusted host platform that enables a trusted multinet architecture in accordance with various embodiments of the invention. The trusted multinet architecture enables a trusted system operating on an independent network to simultaneously securely connect to and operate on multiple independent networks (security domains) without exposing the various security domains to each other, while protecting and maintaining separation of data within each security domain. The user workstation (2110) includes a trusted host platform configured to simultaneously securely connect to and operate on multiple independent networks (security domains) without exposing the various security domains to each other. The trusted host platform includes numerous improvements and refinements over extant systems that permit this functionality to be provided less expensively and with higher reliability and levels of assurance

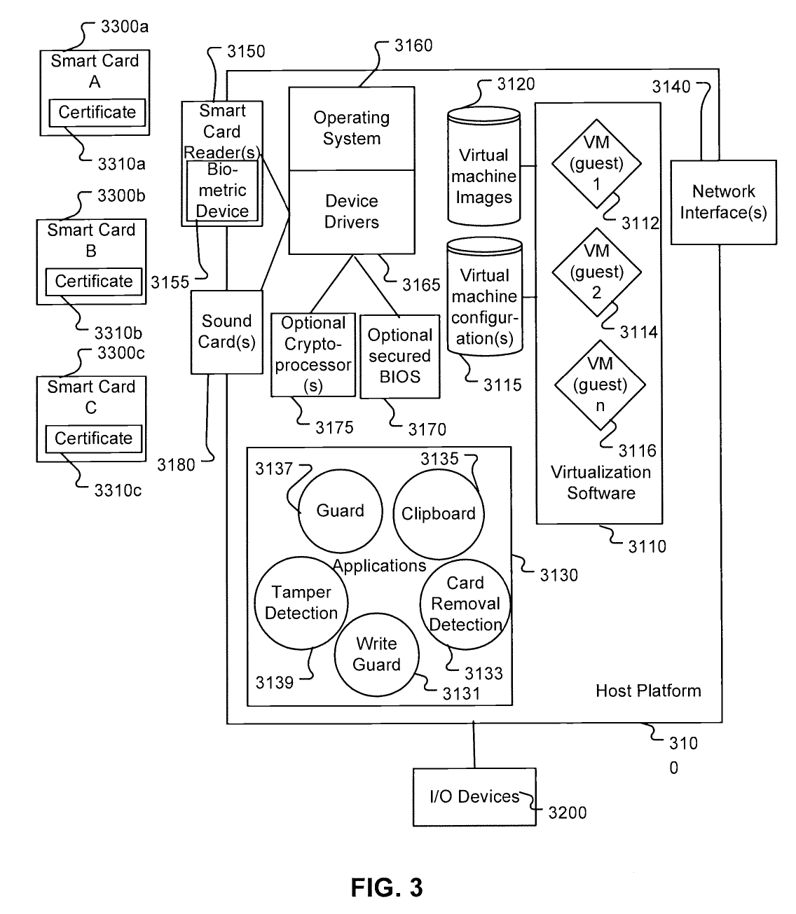

FIG. 3 illustrates a block diagram of a trusted host platform in accordance with various embodiments of the invention. A trusted host platform includes a host computer (3100), I/O devices (3200) (e.g., keyboards, keypads, mouse, and screen), virtualization software (3110), virtualized system images (3120), write guard application (3131), applications software (3130), at least one network interface (3140), at least one smart-card (3300a/b/c), and at least one smart card reader (3150). Each smart card (3300a/b/c) may include at least one certificate (3310a/b/c) for use in connecting to a separate security domain. In some embodiments, the trusted host platform may include at least one digital certificate for use in assuring the configuration of the trusted host platform. The constitution and configuration of these systems and subsystems may be performed using various well-known.

The physical case or other enclosure that encloses the trusted host platform may include interlocks, switches, circuitry, or other components to indicate when the case has been opened or tampered with. These components are referred to collectively as the “physical tamper detection” components of the trusted host platform. The operating system, virtualization software (3110), virtual machine instances (3112, 3114, 3116), or applications software (3130) operating on the trusted host platform may monitor these physical tamper detection components and provide an indication that the case has been opened or tampered with. In some embodiments, the host platform may also use cryptographic techniques to ensure the integrity of firmware, software, and configuration information stored in the host platform. The software and configuration can be stored in any type of memory, such as ROM, FLASH, EEPROM, floppy disk, hard disk, or other memory. These features may be enabled using various well-known techniques.

In some embodiments, the trusted host platform may include hardware and/or software components that affect a “panic button.” These components provide hardware and software mechanisms to effect the shutdown of at least part of the trusted host platform. These features may be enabled using various well-known techniques.

The host computer (3100) includes at least one processor, operably connected to at least one memory device, at least one smart card reader, optional I/O devices (3200), and other computing resources. In some embodiments, the host computer (3100) may also include an operating system (3160) and driver (3165) software, such as Microsoft Windows, Microsoft Embedded Windows, Microsoft Windows CE, Linux, or Symbian. In accordance with various exemplary embodiments, the host computer (3100) may be a stand-alone, dedicated computing device, a personal computer (PC), a hand-held or mobile device, or a consumer appliance, such as a cable set top box. If an operating system is not provided, a BIOS level program loader/monitor can be used in conjunction with the virtualization software (3110) to provide operating system functions.

The BIOS (3170) and operating system (3160) components of the host computer (3100) further may be cryptographically protected to improve reliability and increase tamper resistance. In some embodiments, the BIOS and/or operating system components of the host computer (3100) may use an optional crypto-processor (3175), for example a TPM chip, such as those that are commercially available. One such BIOS is the Phoenix BIOS, version 5, a commercial product that offers cryptographic tamper resistance and defined boot. Alternative techniques include Intel's PXE architecture. These embodiments may be implemented using various well-known methods.

In some embodiments, the host computer (3100) may include at least one network interface (3140) and corresponding network interface “driver” software. Each network interface (3140) may use Ethernet (e.g., twisted pair or fiber), wireless (e.g., 802.11), cellular (e.g., GSM/GPRS), or other networking topology. The host computer driver software may be provided as part of the host computer BIOS (3170) or as part of an operating system running on the host computer (3100). These features may be implemented using various well-known techniques.

A host computer (3100) may include one or more TPM or alternative crypto-processor components (3175) and driver software appropriate for these components. The host computer driver software may be provided as part of the host computer's BIOS (3170) or a part of an operating system running on the host computer (3100). These features may be implemented using various well-known methods.

Other computing resources operably connected to the host computer (3100) may include sound card driver software and one or more sound cards (3180). The host computer driver software can be provided as part of the host computer's BIOS (3170) or a part of an operating system running on the host computer (3100). These features may be implemented using various well-known methods.

The virtualization software (3110) may be a commercial virtualization program, such VMWare, or Microsoft Virtual PC, or other virtualization program. The virtualization software (3110) operates under control of the host computer (3100), and provides mapping between the host computer (3100) and the host computer's computing resources and several virtual machine instances (3112, 3114, 3116). In some embodiments, the virtualization software (3110) shares at least part of the host computer (3100)'s memory, disk, and computing devices, such as smart card readers with at least one virtual machine instance, and provides mapping services so that at least some of the host computer (3100)'s resources are presented to a virtual machine instance (3112, 3114, 3116) as if the virtual machine instance (3112, 3114, 3116) was actually connected to the resource. The virtualization software (3110), its configuration information (3115), and each machine's image (3120) may be cryptographically protected for integrity and privacy (e.g., signed and encrypted), and may be started automatically by the host computer's operating system or BIOS (3170). Each of these operations may be performed using known. A virtual machine image may include one or more virtual machine disk images, configuration information, physical to virtual device mapping information, virtual BIOS images, and other materials used to create running virtual machine instances. A virtual machine image may further include an optional recovery image, which is an disk image of changes to a master virtual machine disk image. The virtualization software integrates the recovery image and the master virtual machine disk image to produce a disk image used to create a virtual machine instance. A virtual machine's image(s) and the running virtual machine instance are sometimes referred to as the “virtual machine”.

In some embodiments of the invention, at least one of: a virtual machine image, a preconfigured virtual machine configuration, and/or a BIOS image are stored in a memory of the host computer (3100) and are referred to as virtual machine image components. The memory of the host computer (3100) may include hard disk, ROM, EEPROM, FLASH, floppy disk, or other persistent memory. These images and/or configurations may be compressed, signed, or encrypted using cryptographic and/or compression techniques to reduce the risk of tampering. In some embodiments, at least one virtual machine image (3120) component may be used in conjunction with cryptographic techniques to encrypt, digitally sign, and/or produce a cryptographic hash of the virtual machine image component. The cryptographic hash may later be used to verify the integrity of the virtual machine image component. If one or more host computer software components (e.g., BIOS, OS, virtualization software, virtual machine images, application software), or parts of these components, are cryptographically protected, there may also be tamper detection application (3139) present in the host computer (3100). The tamper detection application (3139) may be configured to periodically check the cryptographic protections of at least some of the protected components (e.g., host computer (3100) software components, virtual machine image components) and to provide notification if the protected components are changed, altered, or otherwise tampered with. The periodic checks may occur during startup, configuration changes, upon the occurrence of specified events (such as the starting or disconnecting of a VPN session), at timed intervals, or at other criteria. These features may be implemented using known methods.

The materials, including cryptographic hashes, keys, and other cryptographic materials, that can be used to cryptographically check components, are referred to as certification materials.

Similar techniques provide improved protection for integrity and privacy of virtual machine configurations. Optionally, a virtual machine certification materials can be associated with a cryptographic integrity check to ensure that once a virtual machine instance (3112, 3114, 3116) has been associated (and trusted) by a security domain, the contents and configuration of the virtual machine (3112, 3114, 3116) is not tampered with. In some embodiments, a virtual machine's certification materials may be embedded within a security domain machine digital certificate, in an alternate digital certificate, or can be managed externally as part of a certificate structure. In some embodiments, the certification materials may themselves be independently cryptographically protected. In some embodiments, one or more certification materials may be embedded within the host computer's operating system or BIOS. For example, the certification materials may be stored within a protected storage area associated with or managed by the BIOS. In another example, cryptographic keys and other certification materials may be stored within the registry of a host computer (3100). This technique is especially appropriate for host computers using the Microsoft Windows operating system as the host computer's operating system. Other key hiding mechanisms may be utilized wherein certification materials are “hidden” within common files or executables already present on the system. Such key hiding and related obfuscation techniques are conventionally known.

The smart cards (3300a/b/c) described above may be commercially available smart cards, such as commercially available smart cards provided by GemPlus or ActivCard. Other smart cards may be used as would be apparent. Smart cards may be used to store digital certificates (3310a/b/c) and other materials. The smart cards (3300a/b/c) may be single certificate smart cards, in which case the smart card stores a single certificate, or multi-certificate smart cards, in which case the smart card stores several certificates. The digital certificates can be X.509 certificates, though other formats may be used as would be apparent. Other materials may be stored in the smart card (3300a/b/c), such as bindings between a digital certificate and a security domain or network.

A smart card reader (3150) typically includes interface software compatible with the operating system (3160) and/or BIOS (3170) of the host computer (3100), capable of reading and writing a smart card (3300a/b/c), and prompting the user for a personal identification, such as a PIN or biometric identification. Further, the smart card reader (3150) may be virtualized and made available to one or more virtual machines (3112, 3114, 3116) by the commercial virtualization program. This feature may be implemented using known techniques. In some embodiments, operating system components or applications may be provided to monitor, detect, and respond to a “card removal” event. Automatically responding to a card removal event may increase the overall security of the system. The smart card reader interface software may be cryptographically protected to ensure that interfaces with the smart card reader (3150) are not tampered with.

In some embodiments of the invention, authentication devices such as biometric devices such as fingerprint or iris scanners may be used in combination with the smart card reader (3150). In some embodiments, these authentication devices can include dedicated PIN entry devices.

In some embodiments, the virtualization software (3110) provides at least one mapping between several smart card readers operably attached to the host computer (3100) and several virtual machine instances (3112, 3114, 3116). In some embodiments, a one-to-one mapping between a specific smart card reader (3150) and a virtual machine instance (3112, 3114, 3116) is used. In some embodiments, a single smart card reader (3150) is provided and the smart card reader (3150) is shared between the virtual machine instances, and the digital certificates (3310a/b/c) and other materials stored within a smart card (3300a/b/c) are, at least in part, shared between virtual machine instances (3112, 3114, 3116). In some embodiments, a single multi-certificate smart card is managed as distinct virtual “smart cards,” with different virtual “smart cards” being assigned to different virtual machine instances (3112, 3114, 3116) or virtual machine configurations. This mapping between physical smart cards, virtual smart cards, and virtual machine instances (3112, 3114, 3116) can be accomplished on the basis of specific information associated with at least one of the smart card (3300a/b/c), the trusted host platform, a security domain, or a network-based server, using conventional. For example, the mapping may be performed by associating specific domain identifiers, descriptions, or security tags contained within each certificate stored on a smart card and matching tags or domain identifiers stored within each virtual machine's configuration information. In another example, the mapping information may be stored on a smart card (3300a/b/c) itself, within the trusted host platform, or be provided by one or more network-based servers.

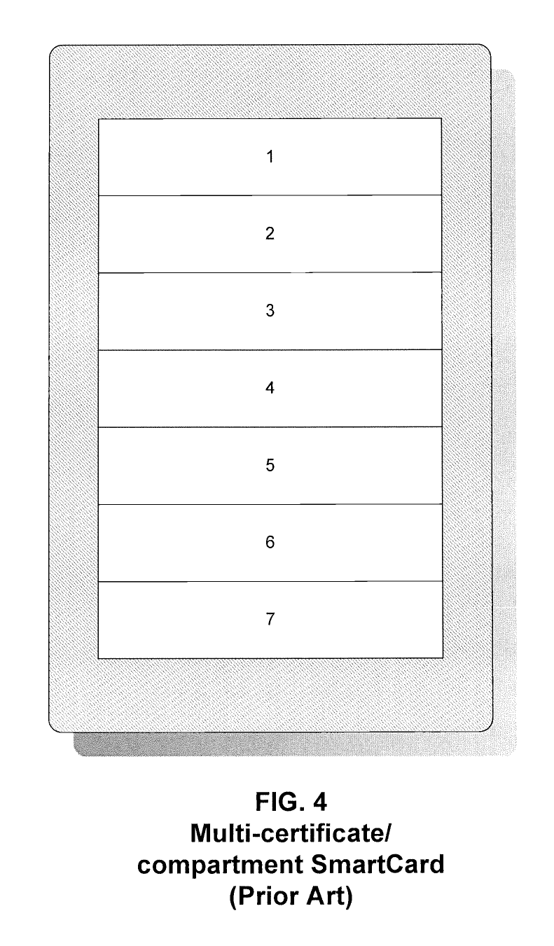

FIG. 4 shows a conventional multiple certificate smart card. In some embodiments of the invention, multiple certificate smart cards are used. In some embodiments, the certificates are X.509 certificates issued by a certification authority associated with each security domain under which a user is authorized. In some embodiments, the X.509 certificate may specify or include information that permits a user to use the certificate, in part or in whole, to connect to, or establish a VPN tunnel to, a specific network. In some embodiments, the X.509 certificate may specify, or include information about, the holder of the smart card. In some embodiments, an X.509 certificate may include information regarding the capabilities, training, or access rights of the smart card holder. The implementation of these embodiments may be performed using conventional techniques known to those of ordinary skill in the art. Other smart cards, such as a commercially available “Java card” or a Fortezza card, may also be used as would be apparent.

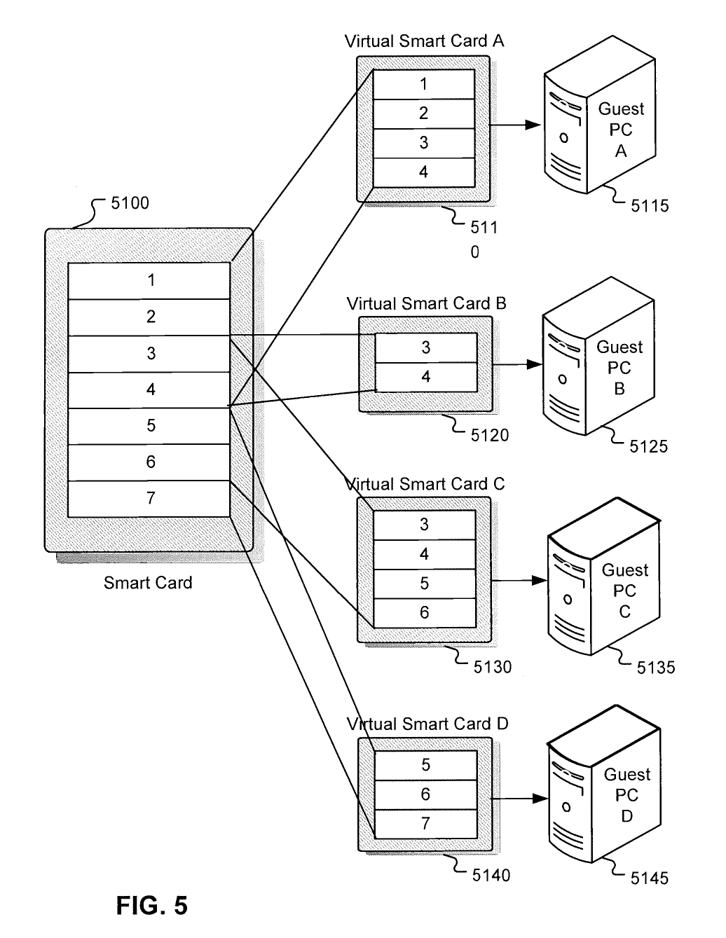

In embodiments where there is more than one certificate (3310a/b/c) stored on a smart card (3300a/b/c) and the smart card is shared between several virtual machine instances (3112, 3114, 3116), the virtualization software (3110) may allocate specific certificates and other stored materials to a specific virtual smart card. For example, certificates associated with a first security domain can be allocated as a single virtual smart card to a first virtual machine (3112, 3114, 3116). As shown in FIG. 5, the mapping of specific certificates to a virtual machine instance (3112, 3114, 3116) provides a virtual machine instance with a “virtual smart card” (5110, 5120, 5130, 5140) including only those materials specifically mapped to the virtual smart card. The virtual smart card (5110, 5120, 5130, 5140) may have certificates for multiple user identities, or may have a single identity certificate (3310a/b/c) that is shared between virtual smart card instances (5110, 5120, 5130, 5140).

A host computer (3100) and virtual machine instances (3112, 3114, 3116) may use cryptographic hardware, such as a TPM chip or other cryptographic hardware (collectively a crypto-processor). In some embodiments, the cryptographic hardware may be configured as part of a smart card (3300a/b/c). Cryptographic processors may be used to speed cryptographic integrity checks, and may be used as a location to store sensitive keys or certificates. As illustrated in FIG. 3, the virtualization software (3110) provides at least one mapping between at least one actual crypto-processor (3175) on the host computer (3100) and at least one virtual machine's virtual crypto-processor. In some embodiments, the virtualization software (3110) may map a specific host crypto-processor to a specific virtual machine instance (3112, 3114, 3116). In some embodiments, the virtualization software (3110) may map the virtual crypto-processor(s) from several virtual machine instances (3112, 3114, 3116) to a single crypto-processor of the host computer (3100). The mapping between virtual machine instances (3112, 3114, 3116) and host computer (3100) resources may be performed using a mapping definition associated with at least one of a smart card, the contents of a smart card, configuration information stored in the host machine, configuration information of the virtualization software (3110), virtual machine configurations (3115), or network server provided information. These operations may be performed using well-known techniques.

As illustrated in FIG. 3, the virtualization software (3110) provides at least one mapping between at least one actual network interface (3140) on the host computer (3100) and at least one virtual machine's virtual network interface. In some embodiments, the virtualization software (3110) may map a specific host network interface (3140) to a specific virtual machine instance (3112, 3114, 3116). In some embodiments, the virtualization software (3110) may map the network interfaces from several virtual machine instances (3112, 3114, 3116) to a single network interface (3140) of the host computer (3100). The mapping between virtual machine instances (3112, 3114, 3116) and host computer (3100) resources may be performed using a mapping definition associated with at least one of a smart card, the contents of a smart card, configuration information stored in the host machine, configuration information of the virtualization software (3110), or network server provided information. These operations may be performed using well-known.

The virtualization software (3110) also provides mapping between at least one actual sound card (3180) on the host computer (3100) and at least one virtual machine's virtual sound card. In some embodiments, the virtualization software (3110) may map a specific sound card (3180) to a specific virtual machine (3112, 3114, 3116). In some embodiments, the virtualization software (3110) may combine and map the sound cards from several virtual machines (3112, 3114, 3116) to a single sound card (3180) of the host computer (3100). The mapping between virtual machines (3112, 3114, 3116) and host computer (3100) resources may be performed using a mapping definition associated with at least one of a smart card, the contents of a smart card, configuration information stored in the host machine, configuration information of the virtualization software (3110), virtual machine configurations (3115), or network server provided information.

In some embodiments, the virtualization software (3110) configurations may be protected using cryptographic techniques. Thus, the mapping between host computer (3100) resources and specific virtual machines (3112, 3114, 3116) may be cryptographically protected, and monitored using tamper detection application (3139) as described above.

According to various embodiments of the invention, each virtual machine (3112, 3114, 3116) implements a VPN connection between the virtual machine (3112, 3114, 3116) and a VPN concentrator present on a network connected to the desired security domain. The VPN endpoint may be preconfigured in the virtual machine image (3120), may be provided as a configuration parameter to the virtual machine image (3120), may be specified within a digital certificate (3310a/b/c), or may be provisioned from a network server using a network protocol such as DHCP. In some embodiments, the VPN connection information may be stored in the smart card (3300a/b/c) with the necessary certificates (3310a/b/c).

Credentials used for authenticating the VPN connection may be, in part, provided by the user, using a commercially available I/O device (3200), such as a keyboard or keypad, or provided by the user in the form of a biometric signature (e.g., a fingerprint or iris print). In some embodiments, at least part of the credentials may be stored within a smart card (3300a/b/c), such as the smart cards described above.

The trusted host platform may include various applications, including applications that are used to increase the integrity and trust of the trusted host platform. These applications may be installed on the host computer (3100), within a virtual machine image (3120), or as part of the BIOS (3175). The applications may also be deployed as device drivers (3165) or interface software in any of these locations. The applications may include firewall, card removal detection application (3133), Guard (3137), Write Guard (3131), clipboard (3135), case tamper detection application, host computer tamper detection application (3139), and/or other applications.

In some embodiments, the trusted host platform provides firewall capabilities. These capabilities may include packet filtering, routing, and Network Address Translation. The firewall component may be embedded in the host computer (3100)'s operating system (3160), or may be provided as a separate component operating within the trusted host platform.

The card removal detection application (3133) detects the removal of a smart card from a card reader, and ensures that the virtual machine connection(s) and VPN tunnel(s) between the trusted platform and the respective networks that use the smart card are disconnected securely. In some embodiments, the card removal detection application (3133) may further notify, or cause a notification to be sent to, at least one monitoring authority to report the card removal event. The monitoring authority may respond to the card removal event by decertifying one or more virtual machine instances (3112, 3114, 3116), including all virtual machine instances (3112, 3114, 3116), on the host platform. In some embodiments, the monitoring authority may decertify or revoke one or more security domain specific certificates, which will prevent the certificate (3310a/b/c) from being successfully used in any virtual machine instance (3112, 3114, 3116). This improves the overall security of the network by breaking network connections if a smart card is unexpectedly removed from the card reader, and may further prevent the card and/or the specific virtual machines (3112, 3114, 3116) from reconnecting to a network.

In a first exemplary use, the card removal detection application (3133) detects the removal of a smart card (3300a/b/c) from a smart card reader (3150) associated with a first virtual machine (3112, 3114, 3116). When the card removal is detected, the card removal detection application (3133) first disassociates the user I/O devices (3200) (e.g., keyboard and mouse) associated with the first virtual machine (3112, 3114, 3116) to prevent additional user interaction with the trusted network within the first security domain. The card removal detection application (3133) then causes the first virtual machine (3112, 3114, 3116) to transmit a message to its network monitoring authority indicating that a smart card was improperly removed from a smart card reader (3150). Subsequently, the card removal detection application (3133) forces a shutdown of the first virtual machine (3112, 3114, 3116), and the termination of the network connection with the trusted network. The card removal detection application (3133) then optionally sends a notification to a public network monitoring authority indicating that a start card (3300a/b/c) was improperly removed from a smart card reader (3150). Then, the card removal detection application (3133) may shut down other virtual machine instances (3112, 3114, 3116) as described above, and may shut down the host computer (3100) as well. In some embodiments, the host computer (3100) may be rendered unable to boot or connect until it is re-provisioned. The determination of which virtual machine instances to shut down is implementation dependant and is based upon the configuration of the card removal detection application. In some embodiments, the card removal detection application shuts down each of the virtual machine instances that are associated with a removed smart card using the smart card reader mapping mechanisms described herein. In some embodiments, the card removal detection application shuts down all virtual machine instances.

The card removal detection application (3133) may monitor “panic button” hardware and/or software components, and effect the shutdown of at least part of the trusted host platform as described above.

The guard application (3137) provides for monitoring of information flow between virtual computers, and particularly between applications operating within virtual machines (3112, 3114, 3116), or providing virtualized services to virtual machines (3112, 3114, 3116). In some embodiments, virtual machine instances are associated with a security tag or other identifier that may be recognized by the “guard” application. The guard application uses its configuration rules and the security tag or other identifier associated with each virtual machine instance to make a determination whether information may be moved from a first virtual machine instance to a second virtual machine instance. In one use, a virtual machine instance (3112, 3114, 3116) may be connected to a desktop representation server within a specific security domain on the network, and may be operating applications in conjunction with this desktop representation server. The virtual machine instance (3112, 3114, 3116) may be provided with screen images that are displayed within the virtual machine's virtual display. In some embodiments, a virtual machine's virtual display is provided in a window of the host operating system's GUI. The guard application (3137) identifies the virtual display and prevents the movement of information from a first virtual machine's virtual display to any other display in accordance with its configuration rules. In some embodiments, the guard application permits movement of information between a first virtual display and a second virtual display, but does not allow information to be moved from the second virtual display to the first virtual display. The guard application (3137) removes the risk of loss or exposure of information based upon unauthorized cut-and-paste operations, or screen capture operations. In some embodiments, depending on the configuration of the guard application (3137), rule-defined movement based upon other attributes of the information between virtual displays may be permitted. In some embodiments, the guard functionality may be included in other applications of the host computer. The write guard application (3131) protects at least some of the BIOS and flash memory images including one or more of the BIOS (3170), operating system (3160), host computer (3100) components, configuration information, and virtual machine images (3120) from unauthorized writing. This prevents corruption and intentional tampering attempts against materials stored in the BIOS (3170) and/or flash memory of the host computer (3100).

In some embodiments of the invention, the clipboard application (3135) cooperates with the guard application (3137) to provide “approved” cut-and-paste operations between virtual machine displays. The clipboard application (3135) monitors the security information, such as a unique tag or ID, associated with each virtual machine's display, and makes determinations as to whether to enable or disable cut, copy, and paste operations of the clipboard on the basis of which virtual machine display is currently provided focus and the contents of the clipboard. The mapping of permitted data movements between tags may be defined in the configuration of the clipboard application (3135). In one example, the clipboard application (3135) will permit the copying of information from an “unclassified” window to the clipboard, and the subsequent pasting of that information to a “classified” window, but might prohibit the pasting of “classified” information into an “unclassified” window. In some embodiments, the restrictions upon use may be, in part, based upon the identity of the user or their location.

The case tamper detection application (3139) detects changes in the case or operating environment of the trusted host platform and performs appropriate actions in accordance with its configuration. In some embodiments, the tamper detection application (3139) may detect a change in state of the physical case or enclosure (e.g., a case tampering event), and send a notification to a monitoring authority as described above. In some embodiments, the tamper detection application shuts down any operating virtual machines if the case is tampered with.

In some embodiments, the case tamper detection application (3139) can alternatively monitor “panic button” hardware and/or software components, and effect the shutdown of at least part of the trusted host platform as described above.

The host computer (3100) tamper detection application (3139) detects changes in the host computer (3100) configuration or operating system components, and performs appropriate actions in accordance with its configurations. In some embodiments, the host computer (3100) tamper detection application (3139) detects changes in the underlying operating system (3160). Detection of changes in operating system components is generally well known and available in commercial packages, such as Tripwire. In some embodiments, the host computer (3100) tamper detection application may be integrated with the host computer (3100) operating system.

Virtual Machine Configuration

In some embodiments of the invention, each virtual machine (3112, 3114, 3116) is stored in a form defined by the machine virtualization software (3110) selected for the trusted host platform. In some embodiments, each virtual machine (3112, 3114, 3116) runs a version of Windows or Linux, although other virtual machine operating systems can be used with the invention. Implementation using VMWare is described for the following non-limiting examples.

The configuration of each virtual machine (31 12, 3114, 3116) may be governed by control information that describes the configuration of the virtual machine (3112, 3114, 3116) stored in one or more control files. For example, when operating using VMWare this control file is a “.VMX” control file. The control information describes a virtual machine's configuration, including virtual disk image, host and virtual devices available to the guest operating system, network configurations, and related information. In some embodiments, the configuration materials may be stored in other locations. Details of the virtual machine's virtual hardware configuration may be controlled. For example, the MAC address of a virtual machine's virtual network interface may be configured using the control file. Additionally, the control information may be used to specify the location of the virtual machine's disk image. In some embodiments, this image may be stored on a file system, such as an encrypting file system, where the virtual machine's disk image is protected using one or more forms of cryptographic protection. In some embodiments, the virtual machine's control information and/or disk image may be downloaded on first use from a remote location and stored in the host computer (3100).

Control information used by a host computer (3100) may be stored within an external storage device such as a smart card or USB key, or in a network repository and be provided to the underlying host computer (3100) in response to a request from the host computer (3100), or the control information can be dynamically generated by either a host computer (3100) or another computer operably connected (including another virtual machine instance) and provided to the host computer (3100). Whatever the source, the control information may be used by the host computer (3100) and the virtualization software (3110) to operate virtual machine instances (3112, 3114, 3116).

In some embodiments, control information describing a specific virtual machine instance (3112, 3114, 3116) may be created and stored within a trusted host platform. In some embodiments, control information describing a specific virtual machine instance (3112, 3114, 3116) may be dynamically generated from other materials, and may be subsequently retained or destroyed in accordance with the system configuration options. Some or all of the materials forming control information (or materials used to generate control information) describing a specific virtual machine instance (3112, 3114, 3116) may be stored within a trusted host platform or be stored in alternate locations such as a network server or a smart card (3300a/b/c). In some embodiments, the virtual machine configuration may be selected or adjusted upon the basis of at least one certificate or other configuration materials such as those stored in a smart card (3300a/b/c) as described above.

In some embodiments, control information describes the smart card reader configuration, and the control information may optionally specify a mapping between the physical smart card (3300a/b/c) and a virtual smart card visible within a specific virtual machine instance (3112, 3114, 3116). This mapping may include the mapping of physical device attributes, and may further specify the mapping of specific certificates or groups of certificates to the virtual machine instance's virtual smart card reader. In some embodiments, the mapping may specify the certificates present in the physical smart card (3300a/b/c) that are visible to the guest operating system operating within a specific virtual machine (3112, 3114, 3116). Specifically, the mapping can specify, either by name, slot/location in the card, or by algorithmically matched attribute (e.g., pattern matching), the certificates that are to be made available to the guest operating system within a virtual smart card, and may optionally specify the layout of the virtual smart card.

In some embodiments, a smart card (3300a/b/c) or smart card reader (3150) may be mapped to a specific virtual machine instance (3112, 3114, 3116) by configuring the smart card or smart card reader within that virtual machine's control information. This mapping may take the form of mapping a specific smart card reader (3150) to a specific virtual machine (3112, 3114, 3116). In some embodiments, the mapping may be more detailed and define a mapping between smart card “slots” in the physical smart card (3300a/b/c) and smart card “slots” provided to the virtual machine (3112, 3114, 3116). The mapping may be one-to-one, many-to-one, or many-to-many, may re-order one or more slots, may omit at least one smart card slot present in the physical smart card (3300a/b/c), or may implement a selection of the slots provided in the physical smart card (3300a/b/c). The selection may be performed on the basis of configuration information previously stored, or may be dynamically performed on the basis of attributes of materials stored within the smart card (3300a/b/c). In some embodiments, the selection may be made, in part, on the basis of the security domain associated with specific materials stored in the smart card (3300a/b/c). For example, all certificates associated with a specific security domain may be mapped to the virtual smart card and exposed to the virtual machine instance (3112, 3114, 3116) for that security domain. Certificates not associated with a specific security domain map cannot be mapped to the virtual smart card. In some embodiments, the selection may be made only in part upon the basis of a specific security domain, and may be made in part on other factors. Thus, a virtual smart card may be constructed using the certificates associated with a specific security domain, as well as any identity certificates present in the smart card (3300a/b/c). Alternate methods of specifying the mapping for smart card contents can also be implemented, including, for example, the specification of the mapping within the control information, the specification as a query-like structure, and storing the specification within the smart card (3300a/b/c) itself.

In some embodiments, the control information specifies certain network parameters, including Ethernet MAC address and the association between at least one virtual machine's network interface and at least one physical network interface (3140) provided by the trusted host platform. The association between a virtual machine's network interface and a physical network interface (3140) can be made, in part, on the basis of network load, security classification, or the security domain to which the virtual machine (3112, 3114, 3116) is to be operably connected.

In some embodiments, different physical network interfaces (3140) may be operably connected to networks that carry different types of network traffic. For example, a first network interface (3140) may be connected to a network that can carry network traffic up to and including a “Secret” security level, while a second network interface (3140) may be connected to a network that carries network traffic at security classifications of “Top Secret” and above. The virtual machine configuration information, in this case, the control information described above, may specify which network(s) a specific virtual machine instance (3112, 3114, 3116) can connect to. In these embodiments, control information may specify that a virtual machine instance (3112, 3114, 3116) may only connect to a specific network by limiting resources, such as available network devices or security domain certificates, that are made available to the virtual machine instance (3112, 3114, 3116). This control information may be dynamically configured to enforce this restriction on the basis of other information, such as a specification of a required security classification for a specific security domain.

In some embodiments, a sound card (3180) may be mapped to a specific virtual machine (3112, 3114, 3116) by configuring the sound card (3180) within that virtual machine's control information. If several sound cards are present on the underlying host computer (3100), the mapping may include specifying at least one of the sound cards to be mapped to a specific virtual machine (3112, 3114, 3116). In some embodiments, several sound cards can be specified for a specific virtual machine (3112, 3114, 3116).

A preconfigured set of operating system and application software provided as a virtual machine (3112, 3114, 3116) is referred to as a virtual machine image (3120). The virtual machine image (3120) may include an operating system, such as Microsoft Windows, Microsoft Embedded Windows, Microsoft Windows CE, Linux, or Symbian. Components of the virtual machine's operating system may be configured to be operable within a specific virtual machine image (3120). These components may include device drivers, machine identity certificates, VPN connection certificates, and related machine identity components. In some embodiments, the machine identity components can be changed when a new instance of a virtual machine (3112, 3114, 3116) is created. One way of making these changes is to have a “baseline” virtual machine image (3120) that includes instructions to run specific configuration customization programs when an instance of the baseline virtual machine image (3120) is started. For example, a customization program may change the machine's SID (for Windows machines). Alternatively, the baseline virtual machine image (3120) may download and install specific security domain machine certificates, VPN connection certificates, or other components to the specific virtual machine image (3120). The customization materials may be provided from a smart card (3300a/b/c) (optionally, a virtualized smart card), a network server, or as part of a configuration and installation protocol. This behavior is advantageous in that it supports a baseline virtual machine image (3120) that can be saved as a new virtual machine image (3120), or as part of a recovery image as described above.

A virtual machine image (3120) may include software and configuration information, including selections from one or more of VPN Software, watchdog software, a desktop representation client such as a Citrix client, and/or a VPN Connectoid.

VPN Software may be commercial VPN software, providing IPSec or L2TP VPN tunneling over IP-based protocols. Examples of commercial VPN software include a Cisco VPN application, which is commercially available, and Microsoft IPSec and L2TP software built into Windows applications. Several VPN software can be provided in a virtual machine image (3120).

In some embodiments of the invention, Watchdog Software running within each virtual machine instance monitors aspects of the virtual machine instance's (3112, 3114, 3116) internal configuration and operating state and shuts down the virtual machine instance (3112, 3114, 3116) if the configuration or operating state changes from a predefined set of acceptable states. The Watchdog Software may also monitor a virtual machine instance's operating system and application software for evidence of tampering, and can take actions including notification or shutting down a virtual machine instance (3112, 3114, 3116) if tampering is detected.

The Desktop Representation client provides terminal emulation/thin client display services to the virtual machine instance (3112, 3114, 3116). In some embodiments, a Citrix client, which is commercially available, is used. In some embodiments, Microsoft's Remote Desktop Connection client may be used instead of a Citrix client. The Desktop Representation client may include configuration information, or may include a specification or configuration information that specifies where and/or how the necessary Desktop Representation connection information may be obtained. In some embodiments, Microsoft's Remote Desktop Connection client can use information stored in the registry of a virtual machine instance (3112, 3114, 3116) to determine connection information for the Desktop Representation Server to which the Remote Desktop Connection client should connect. In some embodiments,, the Desktop Representation client may be configured to obtain the connection information from an alternative source, such as a domain certificate, a network server, or from the user.

A VPN Connectoid provides configuration information to the VPN software. The configuration information may include VPN certificates, but may also include VPN software configuration settings such as encryption methods and encryption strength specifications, endpoint specifications, shared secrets, and other materials required to configure a VPN connection. In some embodiments, a VPN Connectoid may include a specification or configuration information that specifies where and/or how the necessary VPN connection information can be obtained. In some embodiments, the VPN Connectoid may be configured to obtain this information from an alternative source, such as a domain certificate, a network server, or from the user.

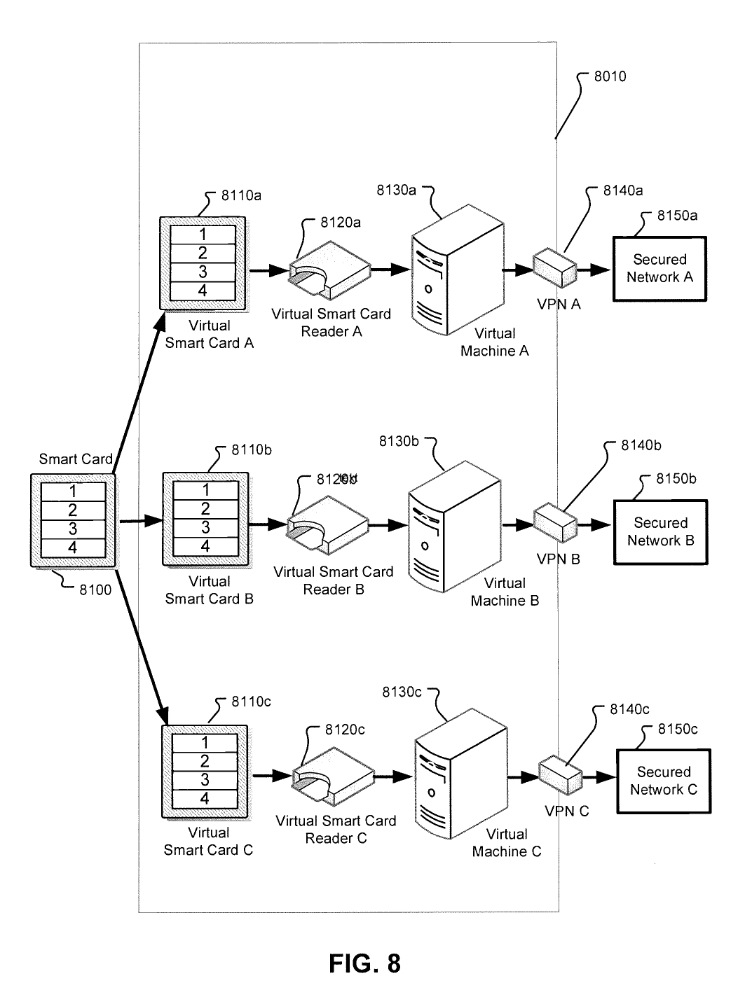

FIG. 8 illustrates the functional information flow between and within a trusted host platform and one or more secured networks in accordance with various embodiments of the invention and is useful for describing the operation and use of the trusted host platform to access these secured networks.

The user inserts a multi-certificate smart card (8100) including a plurality of certificates and other authorization materials that may be used to provide access to the various networks into a smart card reader of the trusted host platform (8000). The trusted host platform reads the smart card and prompts the user for authentication information, which may include a PIN, biometric information, and/or other authentication information, required to unlock the smart card. Upon successful validation of the authentication information, the smart card is unlocked and the certificates and other authorization materials are made available to the trusted host platform. The trusted host platform then inspects the authorization materials stored in the smart card and creates one or more virtual smart cards (8110a/b/c) by assigning one or more of the authorization materials to each virtual smart card, and further associating each virtual smart card with a virtual smart card reader (8120a/b/c) within one or more virtual machine instances (or images, depending upon whether the virtual machines are already started or not) (8130a/b/c). The association may be made by comparing virtual smart card attributes and meta-data stored within the virtual machine instance or image. In some embodiments, the meta-data is stored in the virtual machine configuration information. For example, the meta-data may be stored within a .vmx file used to control a VMWare-based virtual machine.

In some embodiments of the invention, the virtual smart cards are associated with virtual smart card readers provided by the virtualization software of the trusted host platform, and the virtual smart card readers are associated with a virtual machine instance as each virtual machine instance is started. In some embodiments, a plurality of physical smart card readers may be individually associated with virtual machine instances. In these embodiments, the mapping between each physical smart card reader and the virtual machine is provided using the virtualization software and each virtual machine's configuration information as described above.

The trusted host platform provides the user with a selection window (not otherwise illustrated) including each of the secured networks the user is authorized to access. The user selects the secured network they wish to access. The trusted host platform then starts (if not already started) a virtual machine instance for the selected secured network based upon an association between a virtual machine and a secured network. The association may take place using several techniques. In some embodiments, the virtual machine is preassociated with a specific secured network with certificates or other authorization and authentication materials that are stored within the virtual machine image. In other embodiments, the association between a specific virtual machine image or instance is performed “on the fly” using materials from the smart card. In still other embodiments, the association is performed at least in part using materials stored in the virtual machine configuration materials, such as information stored in a .vmx file of a VMWare-based virtual machine. In yet other embodiments, the association is performed on the basis of a table or list of associations stored within the host operating system of the trusted host platform.

In each of the embodiments, the virtual machine instance is started and uses association, configuration, and authorization materials comprising at least one of the following: 1) authorization materials stored in a smart card, 2) authorization materials stored in a virtual machine image, 3) authentication materials stored in a smart card, 4) authentication materials stored in virtual machine image, 5) VPN connection materials stored in a smart card, 6) VPN connection materials stored in a virtual machine image, 7) virtual machine to secure network association materials stored in a smart card, and/or 8) virtual machine to secure network association materials stored in a virtual machine image.

The user then selects which virtual machine they wish to access by selecting its window presented by the host operating system. In some embodiments, the selection of the virtual machine is made automatically using the materials described above and the trusted host platform's host operating system's window focus is shifted to the selected virtual machine window.

Once the virtual machine is started and associated with a secure network, the virtual machine instance establishes a VPN connection to a secured network using at least some of the configuration, connection, authentication, and authorization materials described above. The trusted host platform then runs the desktop virtualization software within the virtual machine instance to connect over the secured VPN channel to a desktop virtualization server within the secured network. The trusted host platform, running the desktop virtualization software, also uses these materials to further ensure the authorization of the user to access the secured network.

Information from each network is protected using the combination of the assured boot and startup process for the trusted host platform and virtual machines that produce an assured processing environment, each virtual machine's hardware and software isolation within the assured processing environment, the VPN connection to protect information exchanged between a virtual machine instance and a secured network, and the authorization, authentication, and VPN connection materials stored in the virtual machine images and smart cards. The trusted host platform may be implemented such that information does not flow between virtual machines (and thus between secure networks) unless specifically permitted such as described below.

In some embodiments, the trusted host platform provides an optional guard and clipboard application that permits the movement of information from one virtual machine's window to another under controlled conditions. The guard and clipboard application may be implemented as separate applications, or as a single application. In either case, information from a first secured network is provided to the user displayed within a first window of the trusted host platform associated with a first virtual machine instance, operably connected using a VPN to the first secured network. The trusted host platform also displays a second window to a second virtual machine instance, operably connected using a VPN to a second secured network. In this example, the first secured network is a network containing sensitive but unclassified materials (e.g., an unclassified network), and the second secured network is a network containing a different, higher security classified materials (e.g., a classified network). The exemplar user's security policy indicates that information may only flow from the sensitive but unclassified network to the classified network. Information flow from each of the networks to each of any other networks, or from the classified network to an unclassified network is prohibited.

The guard/clipboard enforces this security policy by limiting the flow of information as indicated by the security policy. In a first example embodiment, the guard/clipboard uses a security policy specification that indicates how information may flow between the networks that permits the information to flow from an unclassified network, but not in reverse.

The user selects a window for the unclassified network and highlights some text in a document. The guard/clipboard application (3135, 3137 of FIG. 3) recognizes this window as an information source from which information may be taken, and enables the copy/cut operations of the clipboard. The user then copies some text from the first window into the clipboard.

The user then selects a window for the classified network. The guard/clipboard recognizes that the focus has changed, and determines the classification of the window (and the network with which the window is associated). The guard/clipboard determines, using the example policy specification described above, that the information in the clipboard is from a source that permits it to be pasted into the classified network's window, and enables the “paste” option. If a window associated with a network for which pasting is not permitted under the exemplar security policy, the “paste” option would be disabled. The user may then proceed with pasting the information into the second window.

Continuing with the example, the user then selects some text in the second, classified window. The guard/clipboard identifies that the user may cut/copy information from a classified window into a window of the same classification, and permits the cut/copy operation. As the focus is still on the classified window, the “paste” operation is also enabled. When the user changes focus to another window, the guard/clipboard consults the security policy and adjusts the cut/copy/paste capabilities in accordance with the security policy. In this example, if the user selects the unclassified window, the guard/clipboard disables the paste operation of the clipboard as a result of a security policy specification that prohibits information moving from a classified to an unclassified network.

The guard/clipboard may recognize the type or classification of each secured network (and thus the window) based upon a variety of factors. In some embodiments, the security policy may name a specific virtual machine image or virtual machine instance. In other embodiments, the security policy may identify a network address, VPN connectoid, certificate, or other authorization material item as being indicative of the network type. In still other embodiments, each of the window themselves may be tagged with the type or classification of the secured network associated with each of the windows.

Trusted Host Platform/Virtual Machine Provisioning

An end user may be authorized to connect to a specific security domain based upon the machine credentials associated with the trusted host platform and their user credentials stored in at least one certificate (3310a/b/c), such as an X.509 certificate described above. This certificate (3310a/b/c) may include information that identifies the user and their authority to connect.

In some embodiments, several certificates (3310a/b/c) can be used. The certificates can include any of the following: Certificate 1—VPN certificate for network access, Certificate 2—Machine certificate for virtual machine, Certificate 3—User certificate (for identity), Certificate 4—Trusted host platform certificate (optional)

This information be used by the host computer (3100), and one or more virtual machine instances (3112, 3114, 3116), in conjunction with the VPN connectoid, to establish connections to security domains. Various approaches may be used to associate the certificates with one or more virtual machine images (3120).

In some embodiments, the machine and VPN certificates may be stored within each virtual machine image (3120) and thus each virtual machine image (3120) is personalized for a specific security domain. For example, a first virtual machine image contains a first machine certificate and a first VPN certificate, each operable for a first security domain, and a second virtual machine image contains a second machine certificate and a second VPN certificate, each operable for a second security domain, and so on.

In some embodiments, a “master” virtual machine image (3120) is used to start specific virtual machine instances (3112, 3114, 3116), each of which includes several security domain specific certificates. Each virtual machine instance (3112, 3114, 3116) that has been personalized with security domain specific materials may be saved as a “recovery” image. Recovery images may be used by the virtualization software (3110) in combination with the master virtual machine image to recreate a specific virtual machine instance. A recovery image and a “master” virtual machine image are combined to recreate a specific virtual machine instance (3112, 3114, 3116) for subsequent use. This approach is advantageous in that it permits a single master image of a virtual machine, which reduces maintenance and upkeep costs.

In some embodiments, machine and VPN certificates for all authorized security domains may be stored within a “master” virtual machine image (3120), and may be used as necessary to connect to a user-selected security domain. This approach is advantageous in that it reduces the number of personalized virtual machine instances (3112, 3114, 3116) stored on a specific trusted host platform. Optionally, this technique may be combined with the “recovery” image technique described above to record specific security domain selections.

In some embodiments, the machine and VPN certificates may be stored within the host computer operating system or within the host computer's BIOS, and may be provided to the virtual machine during the virtual machine startup in order to configure the virtual machine instance. In some embodiments, the machine an VPN certificates may be stored within a user's smart card (3300a/b/c) and may be made available to each virtual machine instance (3112, 3114, 3116) as the virtual machine instance is started on the basis of the smart card virtualization techniques described above. In these embodiments, a virtual machine instance (3112, 3114, 3116) may identify an available machine certificate and an available VPN certificate within the smart card (3300a/b/c) as part of the boot process, and install these certificates and configure at least one aspect of the virtual machine instance (3112, 3114, 3116) in accordance with information contained within one of these certificates. This “configuration on boot” process is advantageous in that it eliminates the requirement to pre-provision each virtual machine instance (3112, 3114, 3116) in a trusted host platform. Once a virtual machine instance (3112, 3114, 3116) is configured, the virtual machine instance (3112, 3114, 3116) is saved, either as a virtual machine image (3120) or as a recovery image, or alternatively, the virtual machine instance (3112, 3114, 3116) is not be saved at all. The selection as to whether the image is saved or not, and if saved, how it is saved, can be made either by the user, or as a pre-decided choice implemented as part of the virtualization software (3110) configuration. The option of not saving a virtual machine image (3120) is advantageous in that no information about a security domain within a trusted host platform is saved once an operably connected virtual machine instance (3112, 3114, 3116) has been shut down. This enables the use of a trusted host platform in non-access controlled environments such as kiosks.

In some embodiments of the invention, an optional trusted host platform certificate may be used by a trusted host platform to authenticate itself. In some embodiments, a trusted host platform may use this certificate as part of a process to cryptographically verify the integrity of one or more trusted host platform components. In some embodiments, a trusted host platform may use this certificate to establish its identity when sending notifications as described herein.

Smart Card Removal Processing

The trusted host platform can detect the unexpected (including unauthorized) removal of a smart card (3300a/b/c) by a user. In some cases, the trusted host platform can identify and notify at least one network monitoring authority of the event. The process can include a trusted host platform that detects the removal of one or more smart cards from the smart card reader(s) (3150). Trusted host platform can optionally disable the user interface devices associated with each virtual machine (3112, 3114, 3116) associated with an improperly removed smart card (3300a/b/c).

The trusted host platform can cause the virtual machine (3112, 3114, 3116) to issue a notification to a monitoring authority on the trusted network, identifying at least one of: the trusted host platform, a security domain certificate (e.g., a specific machine certificate), a VPN certificate, and associated user certificates.

The virtual machine(s) associated with the removed smart card (3300a/b/c) is shut down and a notification to a monitoring authority on the untrusted network can optionally be issued using at least one of the trusted host platform, a security domain certificate (e.g., a specific machine certificate), a VPN certificate, and associated user certificates.

Upon receipt of an improper smart card removal notification by a network monitoring authority, the network monitoring authority can use information in the notification message to take action. Actions can include de-provisioning at least one of: the smart card (e.g., the smart card holder to be reprovisioned with a new smart card), a user certificate (e.g., the user to be reprovisioned with at least one new user certificate), the trusted host platform (e.g., the trusted host platform to be reprovisioned), and the virtual machine instance (3112, 3114, 3116) (e.g., the virtual machine instance to be reprovisioned).

De-provisioning actions can be effected by revoking one or more digital certificates associated with the user, trusted host platform, or virtual machine instance (3112, 3114, 3116).

Smart Card Provisioning

According to various embodiments of the invention, the trusted host platform may be used to add, modify, or delete certificate(s) (3310a/b/c) on a smart card (3300a/b/c). There are several business processes supporting smart card provisioning. Enrollment is the process in which a smart card is initialized, associated with a user, and populated with at least one security domain user certificate. Self-provisioning is a process in which an authorized user can cause certificates (3310a/b/c) to be added, modified, or deleted on their smart card (3300a/b/c).

Enrollment

An enrollment agent grants the right to issue smart cards containing at least one user certificate to users of a security domain. The user certificate provides proof of identify for the specified user.

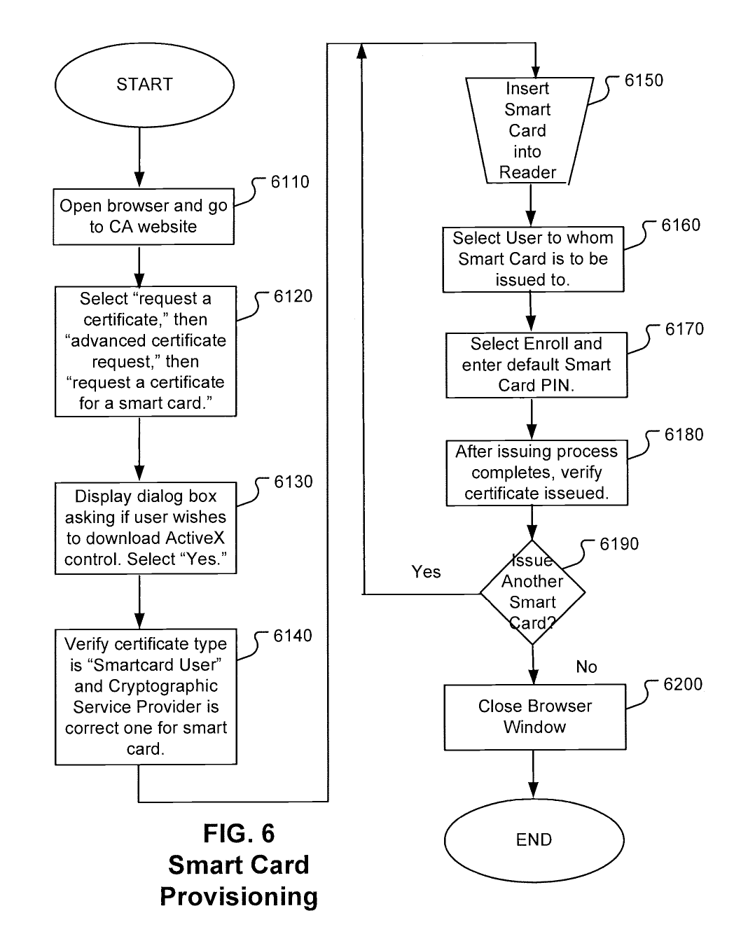

An exemplary process for an enrollment agent to connect to a certification authority (CA) and obtain a user certificate (3310a/b/c) for a smart card (3300a/b/c) is illustrated in FIG. 6. The terms certificate authority and certification authority are used interchangeably herein. With either wording, a CA is a system or systems operable to provide authentication and authorization materials that may be used to prove identity or capability. Examplar authentication and authorization materials include X.509 certificates. Other embodiments of authentication and authorization materials can include items such as Kerberos tickets. Authentication and authorization materials may also include additional materials that may be used to facilitate the use of the authentication and authorization materials, such as security domain identification, specific tags, connection information, and other related information. The following example describes the process for certificates; however the described process can be used to provision any authentication and authorization materials.

An enrollment agent opens a browser and connects to a web site associated with a security domain's certificate authority (operation 61 10). The enrollment agent authenticates to the web site using traditional user ID and password, and optionally uses more advanced (e.g., biometric) authentication methods. In some embodiments, the enrollment agent may present their user certificate from their personal smart card (3300a/b/c), although in some embodiments, this may not be necessary. In these alternate embodiments, the enrollment agent authorization is embodied in the security domain's architecture, for example, by attaching an enrollment agent certificate to the user's Active Directory entry. In some embodiments, an enrollment agent certificate may be provided within the enrollment agent's smart card and may be presented during the authentication process.

After authenticating itself to the web site, the enrollment agent may request that a certificate be issued for a specific end user and stored to a smart card (3300a/b/c). The end user can be any end user of the security domain. The available selections can be controlled by the security domain CA's web site. In an operation 6120 of FIG. 6, the enrollment agent selects that they desire a smart card certificate. Any missing components are downloaded to the enrollment agent's computer, if required (operation 6130).

After the certificate parameters are verified (operation 6140), the enrollment agent inserts the smart card (3300a/b/c) into the smart card reader (3150) (operation 6150), selects the user (if required) (operation 6160), authenticates to the smart card (3300a/b/c) by entering the smart card PIN (or other authentication steps) (operation 6170), thus enabling the smart card (3300a/b/c) to receive the new certificate, and subsequently downloads the certificate into the smart card (operation 6180). If operating within a trusted network platform, the virtualization software (3110) can determine which smart card reader (3150) and the location within the smart card (3300a/b/c) that the certificate is stored to. The certificate is then checked, and the smart card (3300a/b/c) is closed and removed from the smart card reader (3150).

If the enrollment agent desires to enroll another user and their smart card (3300a/b/c), the process is repeated (operation 6190); otherwise, the enrollment agent closes the browser and ends the smart card provisioning session (operation 6195).

Each of the above described actions of the enrollment agent may also be performed to provision the trusted host platform to interact with a security domain. The enrollment agent may additionally be authorized to request and receive machine and domain certificates that enable a computing device to interact with a security domain. An example of this type of certificate is a “windows machine certificate” that is provided to Windows-based computers that are part of a specific security domain. Furthermore, an enrollment agent may further request additional certificates that may be used when establishing VPN connections between a first computer and a specific security domain. The materials may include additional materials that may be used as a VPN connectoid.

Self-Provisioning

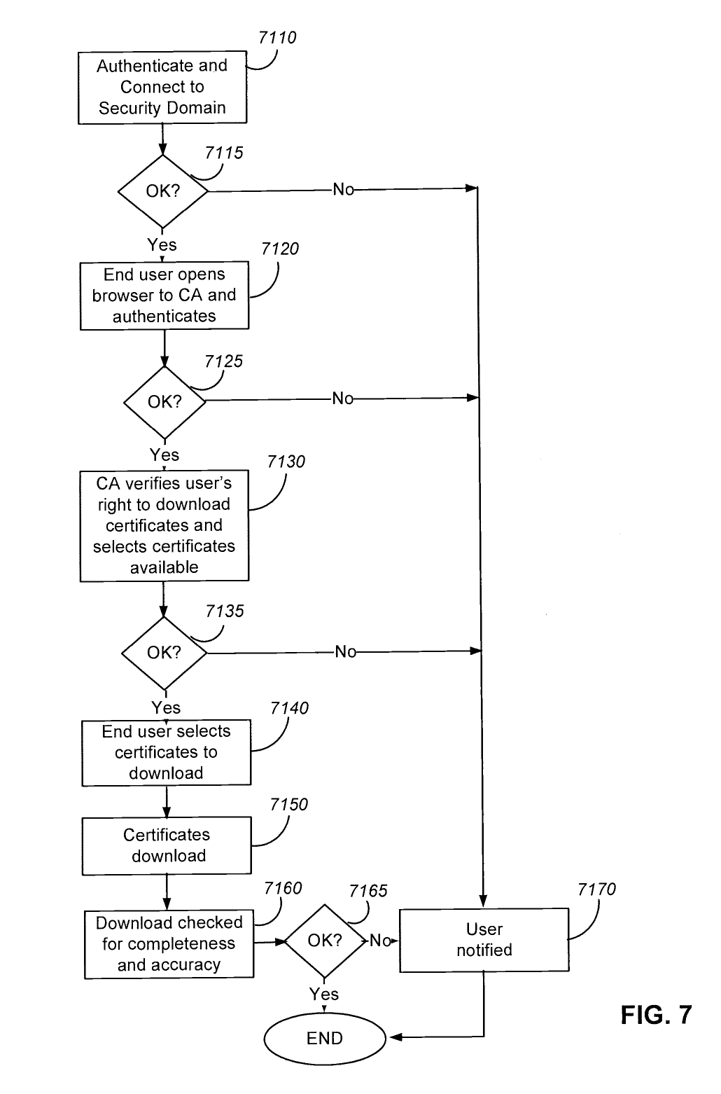

In some embodiments of the invention, a user may self-provision their own smart card with additional certificates, to update certificates already stored in a smart card, to delete expired certificates in order to free up space, and/or other self-provisioning actions. In these embodiments, an authorized end user or other authorized entity may perform the operations shown in FIG. 7 and described below.

An authorized entity authenticates to a trusted host platform and connects to a security domain (operation 71 10). If authentication fails, the end user is not permitted to update their smart card certificates (operation 7115). After authenticating to, and connecting to a security domain, the end user opens a browser and connects to a web site associated with a security domain's certificate authority (operation 7120). In some embodiments, the user may connect through a provisioning domain proxy mechanism to a destination security domain, permitting a user to reach normally unreachable security domains. The end user's certificate (3310a/b/c) from their smart card may be used to authenticate them to the certificate authority's web site. The CA confirms that the end user is authorized to update their certificates by verifying the end user's rights within the security domain's architecture (operation 7130). In some embodiments, the authorization may be present as a certificate (3310a/b/c) attached to the end user's record in an Active Directory. In some embodiments, the authorization may be present as a database entry in a database that contains authorization information. In some embodiments, the end user may always be authorized to copy their certificates to their smart card (3300a/b/c) and the authorization operation can be skipped.

After authenticating themselves to the web site, the end user requests that one or more certificates be issued to themselves for storage in their smart card (3300a/b/c). The available selections are controlled by the security domain CA's web site. In some embodiments, the user requests all certificates be downloaded to their smart card (3300a/b/c). In an operation 7140 in FIG. 7, the end user selects that they desire at least one certificate (3310a/b/c). Any missing components are downloaded to the end user's computer, if required.

After the certificate parameters are verified, the certificates are downloaded into the smart card (3300a/b/c) (operation 7150). If operating within a trusted network platform, the virtualization software (3110) determines which smart card reader (3150) and the location(s) within the smart card (3300a/b/c) that the certificate(s) are stored to. The certificate(s) are then checked to confirm the success of the download (operation 7160), and the download process terminates. If the download is not successful, the user is notified (operation 7170).

Use Cases

In a first example use of the trusted host platform, a trusted host platform may be deployed as a kiosk for provisioning smart cards for individuals who need a single smart card (3300a/b/c) that is operable across several trust domains.

The kiosk, which may include a trusted host platform and/or a ruggedized enclosure, is provided with connections to several networks. Each network may be considered to be an independent trust domain. The kiosk network connection may be made through a common network connection, as shown in FIG. 3, or may include separate network connections as is implementation dependently defined. Each trust domain includes a VPN concentrator, a Certificate Authority, a desktop representation server, such as commercially provided by Citrix, and one or more applications or resources. In a first case, the user desires to update the certificates or rights stored on their smart card from a variety of trust domains. One example of such a case is a smart card (3300a/b/c) including the training, health, and capability certifications for a war fighter. There are often multiple commands without interoperable systems that each provide certifications as to specific training, vaccination, access, checkups, and equipment operation capabilities for an individual war fighter. In this example, there are four disparate non-interoperable systems that provide X.509 certificates to the war fighter. A first security domain provides basic war fighter identity and access to personnel records, a second system provides information related to training records, including certifications related to the successful completion of training related to specific equipment, a third system provides information related to health and vaccinations, including recent checkups, and a fourth system provides and controls physical access to buildings, rooms, and specific lockers.

Each of these systems has been separately developed and can have their own certification authority (CA) that produces their X.509 certificates. In this example, the first security domain produces X.509 certificates attesting to the war fighter's identity and attributes associated with their identity such as rank and service record, as well as X.509 certificates associated with accessing systems within the first security domain. The second security domain produces X.509 certificates related to a war fighter's training, including certifications and specialties, authorizations to operate specific types of equipment, and certificates associated with accessing systems within the second security domain. The third security domain produces X.509 certificates related to a war fighter's health and vaccinations, including specific checkups, requirement health screenings (such as a pre-deployment dental checkup), medical records, and certificates associated with accessing systems within the third security domain. The fourth security domain provides X.509 certificates governing access to one or more buildings, rooms, or other enclosures, including specific equipment lockers or bunkers.

A common problem for a pre-deployment war fighter is attaining all of the necessary signoffs that permit the war fighter to be deployed. In the past, it has involved significant waiting while smart cards are updated manually by office staff. In this example use of the trusted host platform, the war fighter is able to update their system from a single location using virtual network connections to each of the security domains.

Additionally, the trusted host platform can be deployed outside of a secure location, for example, in a HumVee or other mobile location. The tamper resistant and tamper detection mechanisms in the system ensure the integrity of the hardware and software.

In another example, the trusted host platform can be deployed outside of a secure location within a wireless platform such as a ruggedized handheld or dedicated application handheld such as an RFID reader. In one example, such a device might be used to facilitate the update of logistics databases present within at least one security domain. The end user, for example, a supply sergeant managing the loading and unloading of a cargo jet, can require wireless access to several security domains. A first security domain can include logistics information, including information such as incoming flight manifests and RFID information associated with various pallets. A second security domain can include the transportation motor pool information, with up-to-the-minute status of available trucks at the motor pool, although any distinct security domain can be used. Optionally, the user can connect to additional security domains, as required.

The user, when first coming on duty, inserts their smart card (3300a/b/c) containing several identity and security domain specific certificates into a smart card reader (3150) attached to a ruggedized handheld device. The user then uses the ruggedized handheld device to connect to several secured networks, where the user accesses systems on these networks.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method operations of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly of machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user. The user can provide input to the computer system through various input devices such as a keyboard and a pointing device, such as a mouse, a trackball, a microphone, a touch-sensitive display, a transducer card reader, a magnetic or paper tape reader, a tablet, a stylus, a voice or handwriting recognizer, or any other well-known input device such as, of course, other computers. The computer system can be programmed to provide a graphical user interface through which computer programs interact with users.

Finally, the processor optionally can be coupled to a computer or telecommunications network, for example, an Internet network, or an intranet network, using a network connection, through which the processor can receive information from the network, or might output information to the network in the course of performing the above-described method operations. Such information, which is often represented as a sequence of instructions to be executed using the processor, can be received from and outputted to the network, for example, in the form of a computer data signal embodied in a carrier wave. The above-described devices and materials will be familiar to those of skill in the computer hardware and software arts.

It should be noted that the invention employs various computer-implemented operations involving data stored in computer systems. These operations include, but are not limited to, those requiring physical manipulation of physical quantities. Usually, though not necessarily, these quantities take the form of electrical or magnetic signals capable of being stored, transferred, combined, compared, and otherwise manipulated. The operations described herein that form part of the invention are useful machine operations. The manipulations performed are often referred to in terms, such as, producing, identifying, running, determining, comparing, executing, downloading, or detecting. It is sometimes convenient, principally for reasons of common usage, to refer to these electrical or magnetic signals as bits, values, elements, variables, characters, data, or the like. It should be remembered however, that all of these and similar terms are to be associated with the appropriate physical quantities and are merely convenient labels applied to these quantities.

The invention also relates to a device, system or apparatus for performing the aforementioned operations. The system can be specially constructed for the required purposes, or it can be a general-purpose computer selectively activated or configured by a computer program stored in the computer. The processes presented above are not inherently related to any particular computer or other computing apparatus. In particular, various general-purpose computers can be used with programs written in accordance with the teachings herein, or, alternatively, it can be more convenient to construct a more specialized computer system to perform the required operations.

A number of implementations of the invention have been described. Nevertheless, it will be understood that various modifications can be made without departing from the spirit and scope of the invention. Accordingly, other embodiments are within the scope of the following claims.

What is claimed is:

1. A method for providing access from a trusted host platform to a first secured network and from the trusted host platform to a second secured network, the first secured network operating in a first security domain, the second secured network operation in a second security domain, the first security domain separate and distinct from the second security domain, the trusted host platform unsecure from both the first secure network and the second secure network, the method comprising:
instantiating, on the trusted host platform, a first virtual machine associated with the first secured network;
instantiating, on the trusted host platform, a second virtual machine associated with the second secured network;
establishing a first connection between the first virtual machine on the trusted host platform and the first secured network using at least a first virtual secure storage device;
establishing a second connection between the second virtual machine on the trusted host platform and the second secured network using at least a second virtual secure storage device; and
controlling movement of information from within the first security domain to the second security domain.

2. The method of claim 1, further comprising:
unlocking a secure storage device presented by an authenticated user, wherein the secure storage device includes a plurality of authentication materials and a plurality of authorization materials.

3. The method of claim 2, further comprising:
creating the first virtual secure storage device from the secure storage device; and
creating the second virtual secure storage device from the secure storage device.

4. The method of claim 1, wherein the first virtual machine is associated with the first secured network using information stored within the first virtual machine.

5. The method of claim 2, wherein the first virtual machine is associated with the first secured network using information from the secure storage device.

6. The method of claim 1, wherein the first virtual machine is associated with the first secured network using information from configuration materials associated with the first virtual machine.

7. The method of claim 1, wherein the first virtual machine is associated with the first secured network using associations stored within the trusted host platform.

8. The method of claim 1, further comprising associating the first virtual secure storage device with a secure storage device reader associated with the first virtual machine.

9. The method of claim 8, wherein the first virtual secure storage device with a secure storage device reader associated with the first virtual machine comprises associating the first virtual secure storage device with a virtual secure storage device reader associated with the first virtual machine.

10. The method of claim 8, wherein associating the first virtual secure storage device with a secure storage device reader associated with the first virtual machine comprises associating the first virtual secure storage device with a physical secure storage device reader associated with the first virtual machine.

11. The method of claim 2, further comprising:
assigning at least a portion of the plurality of authorization materials to the first virtual secure storage device; and
assigning at least a portion of the plurality of authorization materials to the second virtual secure storage device.

12. The method of claim 2, further comprising:
determining a plurality of secured networks the user is authorized to access based in part upon the plurality of authorization materials from the secure storage device, the plurality of secured networks including at least the first secured network and the second secured network;
presenting the authenticated user with a plurality of selections, each of the plurality of selections corresponding to one of the plurality of secured networks; and
receiving a selection from the authenticated user corresponding to the first secured network.

13. The method of claim 12, further comprising:
establishing a connection between the trusted host platform and the first secured network.

14. The method of claim 1, wherein establishing a first connection between the first virtual machine on the trusted host platform and the first secured network comprises establishing a VPN connection between the first virtual machine on the trusted host platform and the first secured network.

15. The method of claim 2, further comprising associating the first virtual secure storage device with a virtual secure storage device reader associated with the first virtual machine by partitioning the secure storage device within a physical secure device storage reader to provide a first view of the secure storage device relevant to the first virtual machine.

16. The method of claim 2, further comprising mapping a first of the plurality of authentication materials from the secured storage device to the first virtual machine.

17. The method of claim 16, wherein mapping a first of the plurality of authentication materials from the secured storage device to the first virtual machine comprises mapping a first certificate from the secured storage device to the first virtual machine based on a tag within the first certificate.

18. The method of claim 16, wherein mapping the first certificate from the secured storage device to the first virtual machine comprises mapping the first certificate from the secured storage device to the first virtual machine based on a security domain identified within the first certificate.

19. The method of claim 1, wherein controlling movement of information from within the first security domain to the second security domain comprises preventing migration of information from the first security domain to the second security domain.

20. The method of claim 1, further comprising controlling movement of information from within the first security domain to any other security domain.

21. The method of claim 1, wherein controlling movement of information from within the first security domain to the second security domain comprises:
preventing migration of information from within the first security domain to the second security domain; and
permitting migration of information from within the second security domain to the first security domain.

22. The method of claim 1, wherein controlling movement of information from within the first security domain to the second security domain comprises controlling movement of information from within the first security domain to the second security domain based upon a security policy stored in the trusted host platform.

23. The method of claim 1, wherein controlling movement of information from within the first security domain to the second security domain comprises permitting migration of information from within the first security domain to the second security domain when a classification level of the first security domain is less than a classification level of the second security domain.

24. The method of claim 23, wherein controlling movement of information from within the first security domain to the second security domain further comprises permitting migration of information from within the first security domain to the second security domain when a classification level of the information to be migrated to the second security domain is less than a classification level of the second security domain.

25. The method of claim 1, further comprising cryptographically assuring the trusted host platform.

26. The method of claim 25, further comprising:
cryptographically assuring the first virtual machine; and
cryptographically assuring the second virtual machine.

27. A system for providing access from a trusted host platform to a first secured network and from the trusted host platform to a second secured network, the first secured network operating in a first security domain, the second secured network operation in a second security domain, the first security domain separate and distinct from the second security domain, the trusted host platform unsecure from both the first secure network and the second secure network, the system comprising:
a first virtual machine instantiated on the trusted host platform, that is associated with the first secured network;
a second virtual machine instantiated on the trusted host platform, that is associated with the second secured network;
a first virtual secure storage device that establishes a first connection between the first virtual machine on the trusted host platform and the first secured network;
a second virtual secure storage device that establishes a second connection between the second virtual machine on the trusted host platform and the second secured network; and
wherein movement of information from within the first security domain to the second security domain is controlled using the trusted host platform.

28. The system of claim 27, further comprising:
a secure storage device that includes a plurality of authentication materials and a plurality of authorization materials, wherein the secure storage device is unlocked by an authenticated user.

29. The system of claim 28, wherein the first virtual secure storage device is created from the secure storage device, and wherein the second virtual secure storage device is created from the secure storage device.

30. The system of claim 28, wherein the secure storage device within a physical secure device storage reader is partitioned to provide a first view of the secure storage device relevant to the first virtual machine.

31. The system of claim 27, wherein movement of information from within the first security domain to the second security domain is controlled by preventing migration of information from within the first security domain to the second security domain, and permitting migration of information from within the second security domain to the first security domain.

32. The system of claim 27, wherein movement of information from within the first security domain to the second security domain is controlled by permitting migration of information from within the first security domain to the second security domain when a classification level of the first security domain is less than a classification level of the second security domain.

33. The method of claim 32, wherein movement of information from within the first security domain to the second security domain further is controlled by permitting migration of information from within the first security domain to the second security domain when a classification level of the information to be migrated to the second security domain is less than a classification level of the second security domain.

34. The system of claim 27, wherein the trusted host platform is cryptographically assured.

35. The system of claim 34, wherein the first virtual machine is cryptographically assured and the second virtual machine is cryptographically assured.
